(19) United States
(12) Patent Application Publication
(10) Pub. No.: US 2016/0344233 A1
(43) Pub. Date: Nov. 24, 2016

(54) UNINTERRUPTABLE POWER SUPPLY WITH BALANCING BUCK/BOOST CONVERTER

(71) Applicant: ABB Schweiz AG, Baden (CH)

(72) Inventors: Esa-Kai Paatero, Minusio (CH); Juha Lantta, Brissago (CH)

(21) Appl. No.: 15/231,247

(22) Filed: Aug. 8, 2016

Related U.S. Application Data
(63) Continuation of application No. PCT/EP2015/052541, filed on Feb. 6, 2015.

(30) Foreign Application Priority Data
Feb. 7, 2014 (EP) 14154269.6

(51) Int. Cl. H02J 9/06; H02M 7/04; H02M 7/44; H02J 7/00

(52) U.S. Cl. CPC H02J 9/061; H02J 7/0068; H02M 7/04; H02M 7/44

(57) ABSTRACT

A uninterruptable power supply system for supplying an electrical DC load with electric energy from an electrical network comprises an active rectifier connectable to the electrical network for rectifying an AC voltage into a DC voltage, a split DC link to be supplied from the active rectifier, the split DC link comprising two capacitors interconnected in series between a positive output and a negative output of the uninterruptable power supply system, wherein a DC link neutral point is provided between the two capacitors, and a balancing buck/boost converter connected in parallel to the split DC link between the positive output and the negative output and connected via an inductor to the DC link neutral point, such that the buck/boost converter is adapted to balance the two capacitors of the DC link, wherein an unbalance between the two capacitors is generated by one or more electrical DC loads connected between the positive output and the negative output, between the positive output and the DC link neutral point and/or between the negative output and the DC link neutral point.

### FIELD OF THE INVENTION

The invention relates to an uninterruptable power supply, a method for operating an uninterruptable power supply and a controller for an uninterruptable power supply.

### BACKGROUND OF THE INVENTION

Electrical power supplies are dominated by AC power conversion (i.e. power conversion from AC to AC and by AC loads). The worldwide installed infrastructure supports this practice globally. Usually, an AC power conversion is achieved by converting AC to DC by a rectifier and back to DC by an inverter. Usually, a DC link is connected to the intermediated stage. A drawback of this standard double conversion may be a cumulative end-to-end system level efficiency penalty.

In a double conversion power supply, an electrical energy storage may be connected to the intermediate DC link, However, when the load is supplied via the electrical energy storage, there is a DC-to-AC conversion before the load.

There are several alternatives to improve the uninterruptable power supply's system level efficiency when a load is supported by a utility AC network. The uninterruptable power supply may have a bypass path, where the load under nominal conditions is supported by the bypass path. Rectifier and inverter losses may be practically removed and the system efficiency may be improved several percent from approximately 96 to 99%.

It is also possible to remove conversion steps by replacing the double conversion AC uninterruptable power supply with an AC-to-DC uninterruptable power supply (power supply part) to directly supply a step down/buck DC power supply, which is integral to most loads.

### DESCRIPTION OF THE INVENTION

It is an objective of the invention to provide an AC-to-DC uninterruptable power supply with high system efficiently, low AC network distortion, low losses and simple topology.

This objective is achieved by the subject-matter of the independent claims. Further exemplary embodiments are evident from the dependent claims and the following description.

A first aspect of the invention relates to an uninterruptable power supply system for supplying an electrical DC load with electric energy from an electrical network, which, for example, may be a (single phase) 16⅔ Hz. railroad network or may be a (three phase) 230 V/50/60 Hz network with an accessible network neutral. It should be noted that it is possible to only use one phase of the three phase system, but using all phases of the network is also possible. Other voltage levels are also possible.

According to an embodiment of the invention, the uninterruptable power supply system comprises an active rectifier connectable to the electrical network via a line inductor for rectifying an AC voltage into a regulated DC voltage, a split DC link to be supplied from the active rectifier, the split DC link comprising two capacitors interconnected in series between a positive, output and a negative output of the uninterruptable power supply system, wherein a DC link neutral point is provided between the two capacitors and the DC link neutral point as well as at least one of the positive output or negative output are accessible in order to he connected to the DC load, where the DC link neutral point is connected to the network neutral point during operation, and a balancing buck/boost converter connected in parallel to the split DC link between the positive output and the negative output and connected via an inductor of the balancing buck/boost converter to the DC link neutral point, such that the buck/boost converter is adapted to balance the two capacitors of the DC link. Thus the buck/boost converter is capable to balance the energy stored in the two capacitors.

An unbalance between the two capacitors may be generated by one or more electrical DC loads connected between the DC link neutral point and at least one of the positive or negative output.

The uninterruptable power supply further comprises an electric energy storage to be charged by the DC link and for supplying the DC link with electric energy, when the electrical network has a power failure or when due to an overload the electrical network is not capable of solely supporting the DC link.

To balance an unbalanced power drain from one load or different power drains from more than one load connected to the uninterruptable power supply, a buck/boost converter is connected between the DC link outputs and the DC neutral point to transfer energy from one DC link capacitor to the other, for example when the load is single sided with respect to the DC link neutral point or when an unbalanced load is connected to the DC link neutral point as well as to both DC link potentials. In case no balancing back/boost converter would be applied, the unbalanced load would lead to an unbalanced load of the DC link capacitors. The unbalanced DC link capacitors would result in an unbalanced load of the AC network with respect to the positive and negative half-wave of the AC current, which at least should be avoided, for example due to functional and normative limitations on allowable DC components of the network current.

By the uninterruptable power supply system, a two sided independently regulated DC output centered at the DC link neutral point may be generated and one or both sides of the DC link may be connected to an electrical DC load. The connection of the load may be between the DC link neutral point and at least one of the positive or negative output.

As an example, the voltage between the two outputs may be between 350 and 400V. The DC link neutral point is the neutral point of the electrical network.

According to an embodiment of the invention, the positive output, the negative output and/or the DC link neutral point are accessible via an electrical connection element.

According to an embodiment of the invention, at least two loads arc connected to the outputs and the DC link neutral point. For example, a first load may be connected between the positive output and the negative output and a second had may be connected either between the positive output and the DC link neutral point or between the negative output and the DC link neutral point. It also may be possible that a first load is connected between the positive output and the DC link neutral point and that a second toad is connected between the negative output and the DC link neutral point.

According to an embodiment of the invention, the electrical energy storage may comprise a rechargeable battery or accumulator. In a stored energy operation mode, the balancing converter may maintain the regulation of the DC link capacitors versus the neutral point. In such a way, the electrical energy storage may be connected directly to the outputs of the power supply system and/or directly to the load input.

According to an embodiment of the invention, the electrical energy storage is connected between the positive output and the negative output, between the positive output and the DC link neutral point and/or between the negative output and the DC link neutral point.

According to an embodiment of the invention, the uninterruptable power supply system further comprises a second electric energy storage connected between the positive output and the negative output, between the positive output and the DC link neutral point and/or between the negative output and the DC link neutral point. For example, the first electric energy storage may be connected between the positive output and the DC link neutral point and the second electric energy storage may be connected between the negative output and the DC link neutral point.

According to an embodiment of the invention, the rechargeable battery or batteries or accumulator or accumulators of the electrical energy storage might be directly connected or indirectly connected to the DC link by a DC-DC converter.

According to an embodiment of the invention, the uninterruptable power supply system further comprises a further converter, for example a buck/boost converter, connected to the DC link for charging the DC link via an electric energy storage and/or for storing the electric energy storage via the DC link. In such a way, the power supplied to or from the electric energy storage may be regulated and/or the voltage of the electric energy storage may be adapted to the voltage of the DC link.

In general, the active rectifier at the input of the uninterruptable power supply system may be any type of active convertor. It also may be possible that the active rectifier is adapted to rectify one or more phases of a multi-phase input voltage.

According to an embodiment of the invention, the active rectifier is a buck/boost converter. For example, the active rectifier may be a power factor correcting buck/boost convertor for a two wire installation, which has one phase and a neutral, or for a four wire installation, which has three phases and a neutral. The buck/boost converter of the rectifier may operate in conjunction with a separate and/or galvanically connected or isolated converter.

According to an embodiment of the invention, the active rectifier is a buck/boost converter, wherein the buck/boost converter comprises of two semiconductor switches connected in series between the positive output and the negative output and wherein the line inductor is connected with one end between the two semiconductor switches, whereas the other end is connectable to the electric network. By this embodiment electrical energy might be transferred for the electrical network to the DC link as well as from the DC link to the electrical network. The buck/boost converter is thus a bidirectional, active rectifier.

According to an embodiment of the invention, the uninterruptable power supply system further comprises an output converter connected in parallel to the split DC link. The output converter may be a DC-to-AC converter and/or a DC-to-DC converter. This may provide a great flexibility in the choice of energy output types and/or preferential source loading on criteria based for instance on cyclic load life.

According to an embodiment of the invention, the output converter is a buck/boost converter, which may be switched to operate as a DC-to-AC converter or as a DC-to-DC converter.

According to an embodiment of the invention, the balancing buck/boost converter, the further buck/boost converter for charging an energy storage and/or the output buck/boost converter comprises two semiconductor switches connected in series between the positive output and the negative output. In other words, the two semiconductor switches are connected in a half-bridge connection. Furthermore, an inductor is connected with one end between the two semiconductor switches.

According an embodiment of the invention at least one of the semiconductor switches used in the active rectifier the balancing buck/boost converter, further converter, and/or output converter is a bidirectional semiconductor switch with controlled unidirectional current flow, such as a transistor, IGBT and/or ICGT with an antiparallel diode, which usually is called freewheeling diode.

A further aspect of the invention relates to a method for operating an uninterruptable power supply system, for example the uninterruptable power supply system as described in the above and in the following.

According to an embodiment of the invention, the method comprises: rectifying an AC voltage from an electrical network into a DC voltage supplying the DC voltage to a split DC link comprising two capacitors interconnected in series between a positive output and a negative output, wherein a DC link neutral point is provided between the two capacitors and connected with the network neutral point, supplying at least one electrical DC load with electric energy from the DC link, the electrical DC load connected between the DC link neutral point and at least one of the positive output and the negative output, and balancing the two capacitors of the DC link with a buck/boost converter connected in parallel to the split DC link between the positive output and the negative output and connected via an inductor to the DC link neutral point.

For example, it may be that the rectifier, together with the buck/boost converter is controlled in such a way that the power factor at the input of the uninterruptable power supply system is regulated and that simultaneously the capacitors of the DC link are balanced.

According to an embodiment of the invention, the method of balancing further comprises, determining and comparing the charging states of the two capacitors and transferring energy from the one of the two capacitors that is charged higher to the one whose charge is lower.

Thereby a to the DC link neutral point unsymmetrical DC load nonetheless results in an symmetrical energy transfer with respect to the network neutral from the network to the uninterruptable power supply during the positive as well as negative half-wave of the network voltage.

For example, a DC load may be connected between the DC link neutral point and the positive output. All energy provided to the load is drawn from the capacitor connected in parallel to it. This capacitor is charged from the network as well as through the energy transferred from the second capacitor. The second capacitor, connected between the negative output the DC link neutral point, is charged by the network. Therefore, the energy supplied to the load is drawn during both half-waves of the network voltage and the network is loaded symmetrically.

According to an embodiment of the invention, the method further comprises: charging an electric energy storage from the DC link and supplying the DC link with electric energy by discharging the electric energy storage in the case of a failure of the electrical network. The balancing of the capacitors by the buck/boost converter may be performed in a normal operation mode, which is when the power is supplied from the electrical network, and/or in stored energy operation mode, which is when the power is supplied from the electrical energy storage.

According to an embodiment of the invention, the method further comprises: converting the DC voltage provided by the DC link into an AC voltage provided to an AC load and/or converting the DC voltage provided by the DC link into a second DC voltage provided to a DC load. The DC outputs and the DC link neutral point may be used through an additional converter to generate an AC or DC output voltage, for example to support a mixed AC and DC load configuration. For example, a buck/boost converter may be controlled in two different ways that either a DC output voltage or an AC output voltage is generated.

A further aspect of the invention relates to a controller for an uninterruptable power supply system as described in the above and in the following, wherein the controller is adapted for performing the method as described in the above and in the following. For example, the controller may control an active rectifier, the buck/boost converter and optionally the further auxiliary power supply converter and/or optionally the output converter by controlling the gates of the semiconductor switches of these converters.

For example, the controller may comprise a processor and software executed on the processor such that the method may be performed. However it is also possible that the method is at least partially implemented in hardware.

It has to be understood that features of the uninterruptable power supply system as described in the above and in the following may be features of the controller and the method as described in the above and in the following.

These and other aspects of the invention will be apparent from and elucidated with reference to the embodiments described hereinafter.

### BRIEF DESCRIPTION OF THE DRAWINGS

The subject-matter of the invention will be explained in more detail in the following text with reference to exemplary embodiments which are illustrated in the attached drawings.

FIG. 1 schematically shows an uninterruptable power supply system according to an embodiment of the invention.

FIG. 2 schematically shows a semiconductor switch for the uninterruptable power supply system of FIG. 1.

FIG. 3 schematically shows an uninterruptable power supply system according to a further embodiment of the invention.

FIG. 4 schematically shows an uninterruptable power supply system according to a further embodiment of the invention.

FIG. 5 shows a flow diagram for a method for operating an uninterruptable power supply system according to a further embodiment of the invention.

The reference symbols used in the drawings, and their meanings, are listed in summary form in the list of reference symbols. In principle, identical parts are provided with the same reference symbols in the figures.

### DETAILED DESCRIPTION OF EXEMPLARY EMBODIMENTS

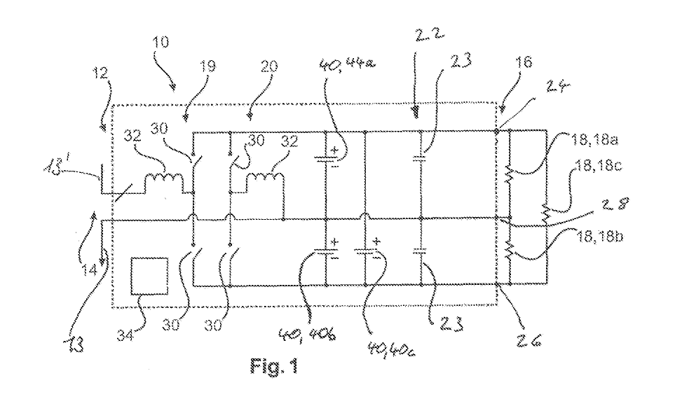

FIG. 1 shows an uninterruptable power supply system 10 that at an input 12 is connected to an electrical network 14 via a line inductor 32 and at an output 16 is connected to one or more DC loads 18. The uninterruptable power supply system 10 may for example be for train or railroad applications. The electrical network 14 may be a (single phase) 16⅔ Hz railroad network or may be a (three phase) 230 V/50/60 Hz network.

The uninterruptable power supply system 10 comprises an active rectifier 19, a balancer 20 implemented as a balancing buck/boost converter and a DC link 22 connected in series between the input 12 and the output 16.

The split DC link 22 comprises two capacitors 23 connected in series between a positive output 24 and a negative output 26. Between the two capacitors, a DC link reference or neutral point 28 is provided, which during operation is connected with the neutral point 13 of the electrical network 14. The neutral point 13 of electrical network 14 is also called network neutral point.

Both the active rectifier 19 and the balancer 20 may be buck/boost converters. They both may have two semiconductor switches 30 connected in series between the positive output 24 and the negative output 28. A midpoint between the two switches 30 of the rectifier 19 is connected via an inductor 32 to a phase of the electrical network 14. A midpoint between the two switches 30 of the balancer 20 is connected via an inductor of the balancer 32 to the DC link neutral point 28.

A controller 34 is adapted for controlling the rectifier 19 and the balancer 20 by generating switching signals for the switches 30. The controller 34 may receive sensor inputs from current and voltage sensors all over the system 10, from which all voltages and current in the system 10 may be derived. These voltages and currents may be regulated by the control of the controller 34, for example for controlling the power factor correction at the input 12 and/or for controlling the balancing of the capacitors 23 of the DC link 22 (by bi-directionally transferring energy from one DC link capacitor 23 to the other).

One or more DC loads 18 may be connected to the output 16 of the uninterruptable power supply system 10 by electrical connection elements such as clamps, plugs or the like. For example a load 18a may be connected between the positive output 24 and the DC link neutral point 28, a load 18b may be connected between the negative output 26 and the DC link neutral point 28 and/or a load 18c may be connected between the positive output 24 and the negative output 26. The loads 18a, 18b, 18c are DC loads.

Further, FIG. 1 shows one or more electric energy storages 40 that, for example, may comprise acid lead batteries. An energy storage 40a may be connected between the positive output 24 and the DC link neutral point 28. An energy storage 40b may be connected between the negative output 26 and the DC link neutral point 28 and/or an energy storage 40d is connected between the positive output 24 and the negative output 26. Instead of connecting the electric energy storage 40 directly to the DC link it could also be connected to the DC link by a DC-DC converter.

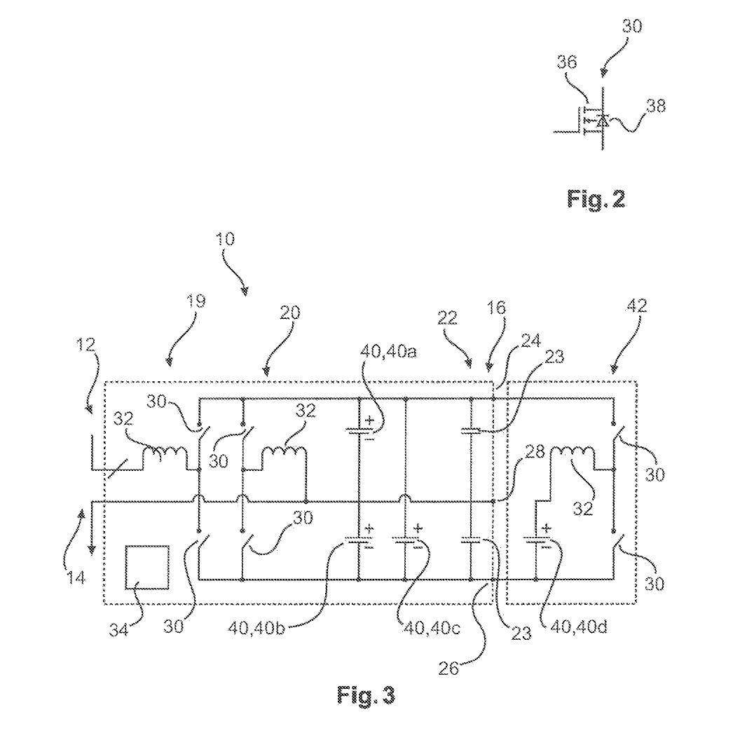

FIG. 2 shows an example of a semiconductor switch 30 that may be used in the uninterruptable power supply system of FIG. 1. The semiconductor switch 30 may comprise an external switchable component 36, such as a transistor, IGBT or IGCT, and a diode 38 that is connected antiparallel to the component 36.

FIG. 3 shows essentially the uninterruptable power supply system of FIG. 1. In addition or alternatively to the different energy storage 40 shown in FIG. 1, an energy storage 40d may be connected via a further converter 42 to the DC link 16. The converter 42, which may be an integral or separate (external) converter with respect to the other components of the uninterruptable power supply system 10, may be controlled by the controller 34. The converter 42 may be a DC-to-DC converter of either uni-directional or bi-directional operation capability.

The converter 42 also may be one buck/boost converter or multiple buck/boost converters with two series connected semiconductor switches 30 connected between the positive output 24 and the negative output 26 per converter and/or between the DC link neutral point 28 and the positive output 24 or negative output 26 per converter. A midpoint between the two semiconductor switches 30 of the converter 42 may be connected via the electric energy source 40d with the positive output 24, the negative output 26 or the DC link neutral point 28.

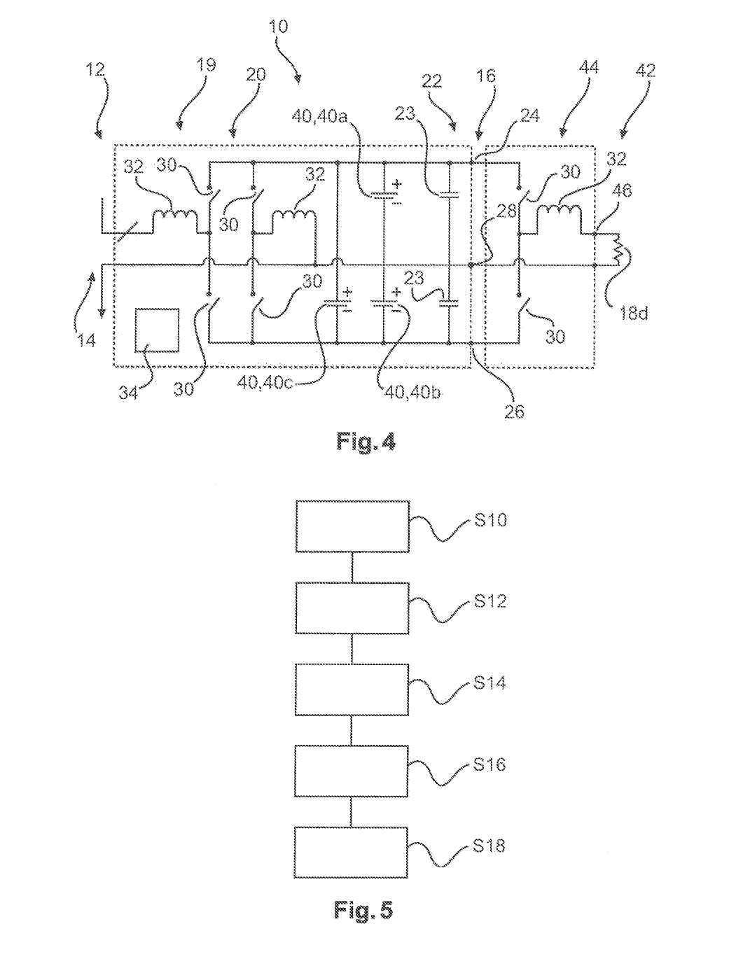

FIG. 4 shows a further uninterruptable power supply system 10 similar to the previous described one with an output converter 44 connected to the output 16 of the uninterruptable power supply system 10. The converter 44, which may be an integral or separate (external) converter with respect to the other components of the uninterruptable power supply system 10, may be controlled by the controller 34. The converter 44 also may be a buck/boost converter with two series connected semiconductor switches 30 connected between the positive output 24 and the negative output 26. A midpoint between the two semiconductor switches 30 of the converter 42 may provide an AC output 46.

Alternatively, the converter 44 and/or the series connected switches 30 may be connected between the positive output 24 and the DC link neutral point 28 or between the negative output 26 and the DC link neutral point 28.

An AC load 18d may he connected between the AC output 46 and the neutral point 28.

It has to be understood that the converter 42 with energy storage 40d and the output converter 44 of FIGS. 3 and 4 may be combined in one uninterruptable power supply system 10.

FIG. 5 shows a flow diagram for operating the uninterruptable power supply system 10, optionally with the converters 42 and/or 44.

In step S10, an AC voltage from the electrical network 14 is rectified into a DC voltage by the active rectifier 19. For example, the switches 30 of rectifier 19 may be opened and closed by the controller such that the power factor of the uninterruptable power supply 10 is actively corrected. The DC voltage is then supplied to the split DC link 22.

Simultaneously, an electric energy storage 40 may be charged from the DC link 22. The electric energy storages 40a, 40b, 40c are always charged, when there is a positive energy flow from the electrical network 14. In the ease of the electric energy storage 40d, the converter 42 may he switched correspondingly until the electric energy storage 40d is completely charged.

Step S10 is performed, when the electrical network is active, in the case, the electrical network has a failure, step S12 is performed. In step S10, the controller 34 may operate in a normal operation mode and in step S12, the controller 34 may operate in a stored energy operation mode.

In step S12, the DC link 22 is supplied with electric energy by discharging the electric energy storage 40. For example, the converter 42 may be switched to control the discharging of the electric energy storage 40d.

In step S14, the one or more electrical loads 18a, 18b, 18c are supplied with electric energy from the DC link 22, either from the electrical network 14 or from one or more of the electric energy storages 40.

In step S16, the two capacitors 23 of the DC link 22 are balanced with the buck/boost converter 20, which may be correspondingly switched by the controller 34. The method of balancing comprises, determining and comparing the charging states of the two capacitors; and transferring energy from the one of the two capacitors which is charged higher to the one whose charge is lower. Step S16 may be performed in the normal operation mode and the stored energy mode.

When the converter 44 is present, in step S18, the DC voltage provided by the DC link 22 is converted either into an AC voltage provided to an AC load or into a second DC voltage provided to a DC load. The converter 44 may he switched by the controller 34 either for generating an AC output voltage or a DC output voltage.

For example, the converter may be operated by the controller 34 in the following ways: The converter 44 may operate as a current limiting device. The converter 44 may operate as an adjustable voltage source for control of a load voltage independently of the DC link voltage. The convertor 44 may operate as a current and/or voltage control device, such as for controlled pick-up or turn-off of a load. The converter 44 may change its mode of operation from continuous conduction to current limiting to minimize system losses.

While the invention has been illustrated and described in detail in the drawings and foregoing description, such illustration and description are to be considered illustrative or exemplary and not restrictive, the invention is not limited to the disclosed embodiments. Other variations to the disclosed embodiments can he understood and effected by those skilled in the art and practising the claimed invention, from a study of the drawings, the disclosure, and the appended claims. In the claims the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be constructed as limiting the scope.

### LIST OF REFERENCE SYMBOLS

10 uninterruptable power supply system

12 input

13 network neutral point

13′ phase conductor

14 electrical network

16 output

18 load

18a 18b, 18c DC load

18d AC load

19 active rectifier

20 balancer

22 DC link

23 capacitor

24 positive output

26 negative output

28 DC link neutral point

30 semiconductor switch

32 inductor

34 controller

36 external controllable switch

38 diode

40, 40a, 40b, 40c, 40d electric energy storage

42 auxiliary power converter

44 AC output converter

46 AC output

1. An uninterruptable power supply system for supplying an electrical DC load with electric energy from an electrical network, the electrical network having an accessible network neutral point and at least one phase conductor, the uninterruptable power supply system comprising:
an active rectifier connectable to the electrical network via a line inductor for rectifying an AC voltage into a regulated DC voltage;
a split DC link to be supplied from the active rectifier, the split DC link comprising two capacitors interconnected in series between a positive output and a negative output of the uninterruptable power supply system, wherein a DC link neutral point is provided between the two capacitors and the DC link neutral point as well as at least one of the positive output or negative output are accessible in order to be connected to the DC load, were the DC link neutral point is connected to the network neutral point during operation;
a balancing buck/boost converter connected in parallel to the split DC link between the positive output and the negative output and connected via an inductor of the balancing buck/boost converter to the DC link neutral point, such that the buck/boost converter is adapted to balance the two capacitors is generated by one or more electrical DC loads connected between the DC link neutral point and at least one of the positive or negative output; and
an electric energy storage to be charged by the DC link and for supplying the DC link with electric energy, when the electrical network has a power failure.

2. The uninterruptable power supply system of claim 1, where the positive output, the negative output or the DC link neutral point are accessible via an electrical connection element.

3. The uninterruptable power supply system according to claim 1,
wherein the electrical energy storage is connected between the positive output and the negative output, between the positive output and the DC link neutral point between the negative output and the DC link neutral point.

4. The uninterruptable power supply system according to claim 1, further comprising:
a second electric energy storage connected between the positive output and the negative output, between the positive output and the DC link neutral point or between the negative output and the DC link neutral point.

5. The uninterruptable power supply system according to claim 1, further comprising:
a further converter connected to the DC link for charging the DC link via an electric energy storage or for storing the electric energy storage via the DC link.

6. The uninterruptable power supply system of claim 5,
wherein the further converter is a buck/boost converter.

7. The uninterruptible power supply system according to claim 1,
wherein the active rectifier is a buck/boost converter.

8. The uninterruptable power supply system of claim 7,
wherein the buck/boost converter of the rectifier comprises two semiconductor switches connected in series between the positive output and the negative output;
wherein the line inductor is connected with one end between the two semiconductor switches, whereas the other end is connectable to the electric network.

9. The uninterruptible power supply system according to claim 1,
wherein the balancing buck/boost converter comprises two semiconductor switches connected in series between the positive output and the negative output;
wherein the inductor of the balancing buck/boost converter is connected with one end between the two semiconductor switches.

10. The uninterruptable power supply system according claim 1, further comprising:
an output converter connected in parallel to the split DC link;
wherein the output converter is a DC-to-AC converter or a DC-to-DC converter.

11. The uninterruptable power supply system of claim 10,
wherein the output converter is a buck/boost converter.

12. The uninterruptable power supply system according to claim 1,
wherein at least one of a semiconductor used in the rectifier or buck/boost converters is a bidirectional semiconductor switch with controlled unidirectional current flow.

13. A method for operating an uninterruptable power supply system according to claim 1, the method comprising:
rectifying an AC voltage from an electrical network into a DC voltage;
supplying the DC voltage to a split DC link comprising two capacitors interconnected in series between a positive output and a negative output, wherein a DC link neutral point is provided between the two capacitors and connected with the network neutral point;
supplying one or more electrical DC loads with electric energy from the DC link, the electrical DC load connected between the DC link neutral point and at least one of the positive output or the negative output; and
balancing the two capacitors of the DC link with a buck/boost converter connected in parallel to the split DC link between the positive output and the negative output and connected via an inductor to the DC link neutral point.

14. The method according to claim 13, wherein the balancing comprises,
determining and comparing the charging states of the two capacitors; and
transferring energy from the one of the two capacitors which is charged higher to the one whose charge is lower.

15. The method of claim 13, further comprising:
charging an electric energy storage from the DC link; and
supplying the DC link with electric energy by discharging the electric energy storage in the case of a failure of the electrical network.

16. The method of claim 13, further comprising:
converting the DC voltage provided by the DC link into an AC voltage provided to an AC load; and
converting the DC voltage provided by the DC link into a second DC voltage provided to a DC load.

17. (canceled)

18. The uninterruptable power supply system according to claim 2,
wherein the electrical energy storage is connected between the positive output and the negative output, between the positive output and the DC link neutral point or between the negative output and the DC link neutral point.

19. The uninterruptable power supply system according to claim 2, further comprising:
a second electric energy storage connected between the positive output and the negative output, between the positive output and the DC link neutral point or between the negative output and the DC link neutral point.

20. The uninterruptable power supply system according to claim 3, further comprising:
a second electric energy storage connected between the positive output and the negative output, between the positive output and the DC link neutral point or between the negative output and the DC link neutral point.

21. The uninterruptable power supply system according to claim 2, further comprising:
a further converter connected to the DC link for charging the DC link via an electric energy storage or for storing the electric energy storage via the DC link.
